(19) United States
(12) Patent Application Publication
(10) Pub. No.: US 2014/0217827 A1
(43) Pub. Date: Aug. 7, 2014

(54) APPARATUS FOR AND METHOD OF OPERATION OF A POWER INVERTER SYSTEM

(71) Applicants: Christopher Michael Cheek, Concord, MA (US); Peter James Faill, Groton, MA (US); Michael Jay Datta, Somerville, MA (US)

(72) Inventors: Christopher Michael Cheek, Concord, MA (US); Peter James Faill, Groton, MA (US); Michael Jay Datta, Somerville, MA (US)

(73) Assignee: 3L POWER LLC, Waltham, MA (US)

(21) Appl. No.: 14/170,044

(22) Filed: Jan. 31, 2014

Related U.S. Application Data
(60) Provisional application No. 61/759,790, filed on Feb. 1, 2013.

(51) Int. Cl. H02M 7/5387; H02J 9/04

(52) U.S. Cl. CPC H02M 7/5387; H02J 9/04
USPC 307/66; 363/132; 307/64

(57) ABSTRACT

A power inverter system consists of a connection to a primary DC power source, a connection to an AC grid or load, a plurality of switching elements and filter elements to connect the DC power source to the AC grid or load, three power rails internal to the inverter, and a buck/boost circuit to provide a third power rail. The invention allows for simple transformerless grounded or ungrounded connection of a DC power source to an AC grid or load. The voltage rail that is not directly connected to the primary DC power source can be connected to an auxiliary DC power source without any significant additional hardware.

### CROSS-REFERENCES TO RELATED APPLICATIONS

This application claims priority to provisional patent application 61759790.

### BACKGROUND

When multiple electric power sources are connected to the same transmission/distribution grid, each source is often galvanically isolated from the grid by a transformer. The transformer can provide AC voltage step-up or step-down to match the voltage at the point of connection, but a transformer is usually required irrespective of voltage matching to meet DC current injection limits, electromagnetic interference limits, and ground current limits. The transformer decouples common mode voltages between the power source and the grid or load so that the generation inverter can operate without concern for common mode voltages and currents.

AC transformers are heavy, however; and they use a lot of expensive conductor and core materials whose raw material prices have been climbing for the past several decades. To save costs, gain efficiency, preserve natural resources, and allow for a lighter product that is more easily installed, many solar photovoltaic installations in Europe employ systems that do not include isolation transformers. Such transformerless systems have had wide success in Europe, but they have not translated into wide acceptance in the U.S. because these transformerless systems require that one of the rails of the DC power source (strings of photovoltaic panels, for example) be grounded. In the U.S., the overwhelming majority of renewable energy installations include grounded power sources, as the NEC rules for grounded installations are mature and have been used and proven by contractors at sites all over the country.

Transformerless inverter circuits of the prior art include the common H4 circuit as described, for example, in the introduction of German Patent DE 102 21 592 A1/US Patent Application Publication US 2005/0286281 with floating DC and AC output; the H5 circuit further illustrated in US 2005/0286281; the HERIC topology shown in US Patent US 20050174817; the full-bridge DC bypass (D6) topology shown in US Patent US 2009/0316458 A1; the standard 3-level neutral point clamped topology discussed in U.S. Pat. No. 4,443,841, and the alternative neutral point clamped topology introduced in US Patent US 2009/0003024 A1.

All of these systems of the prior art require that the power source be ungrounded (neither positive nor negative rail grounded) when the AC connection has a ground reference, or that the power source be center-point grounded by some method. Bipolar arrays can be center-grounded and connected to 3-level drives with neutral connections, but bipolar arrays are more difficult to wire and put more constraints on site design. What is needed is a reliable, cost effective inverter system that allows for simple grounding of the DC power source as well as transformerless operation. Such a system could allow for wider acceptance of low-cost transformerless inverter systems in places like the U.S., bringing down the hard and soft costs for renewable power system installation.

The invention disclosed herein solves the need for a transformerless, grounded power inverter system, while also preserving efficiency advantages of the transformerless inverters of the prior art and allowing for further cost reduction in the DC-side filter. The present invention also provides a wide-range DC input without the use of separate DC/DC conversion, and it allows for simple integration with energy storage or a secondary power source without the addition of any other significant hardware.

### BRIEF SUMMARY OF INVENTION

Various embodiments of the invention include a DC electrical power source, a connection to the DC power source, a connection to an AC grid or AC load, and an inverter that contains 1) a positive DC voltage rail, 2) a negative DC voltage rail, 3) a plurality of switching elements that can connect each leg of the AC grid or load to either the positive or negative rail, and 4) a buck/boost circuit that drives one of the rails from the opposite rail and a voltage level between the positive and negative rail. Another embodiment includes the connection of an auxiliary power supply or energy storage device to the derived rail to serve as a power control or energy storage mechanism. The present invention can be used to connect a lower voltage grounded or ungrounded two-wire power source to a higher voltage AC grid or load without the use of a transformer or additional DC/DC conversion.

### BRIEF DESCRIPTION OF THE DRAWINGS

FIG. 1 is a block diagram of an embodiment of the present invention and how it connects to a DC power supply and the AC grid or AC load.

FIG. 2 is a schematic view of an embodiment of the present invention wherein the primary power source is a photovoltaic array, the primary power source connects to the inverter's positive rail and neutral rail, an internal buck/boost circuit derives the inverter's negative rail, and a simple H-bridge drives a single-phase grid output with a terminal for neutral or ground.

FIG. 3 is a graph that shows 60 Hz grid voltage along with inverter power output and buck/boost circuit power output under one operating methodology embodiment.

FIG. 4 is a schematic view of the same basic invention embodiment shown in FIG. 2, but with the derived rail connected to an auxiliary power supply in the form of an electric battery.

FIG. 5 is a schematic view of the same basic topology shown in FIG. 2, but with the drive's neutral point accessible to the inverter's phase outputs via an embodiment of 4-quadrant reverse blocking switches.

### DETAILED DESCRIPTION

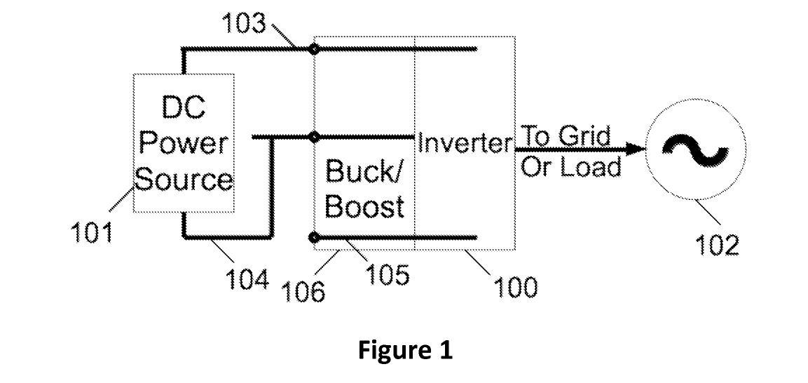

FIG. 1 illustrates one embodiment of the present invention. The power inverter 100 of the present invention is utilized to connect a DC power source 101 to an AC electrical distribution grid or load 102. The DC power source 101 can consist of any native DC power source, such as with photovoltaic arrays, or any rectified AC source, such as with a rectified wind turbine generator or rectified gas turbine generator. The power inverter 100 can be any single or multi-phase electric power inverter capable of converting DC power from the DC power source 101 into AC voltage or current for use by the AC grid or AC load 102, in which 1) the DC power source 101 only supplies voltage to one voltage rail 103 and a point between the two power rails 104, and 2) the opposite rail 105 is powered by a buck/boost circuit 106 (hereafter referred to as the “derived rail”). The AC grid or load 102 can consist of a single-phase, 3-phase or multi-phase network in which a plurality of AC power sources and loads are connected, or it can consist of a local AC load. Any of the components of the inverter 100, the power source 101, or components within the inverter, such as switching totem poles or buck/boost circuits 106 each may consist either singly or as a plurality of such components or systems. The buck/boost circuit 106 can be an integrated part of the inverter 100, or it can be an external circuit. The present invention covers the power inverter 100 and buck/boost converter 106 in various embodiments and the control methodology that allows the inverter 100 and buck/boost converter 106 together to drive power from the DC source 101 to the AC grid/load 102 under various configurations.

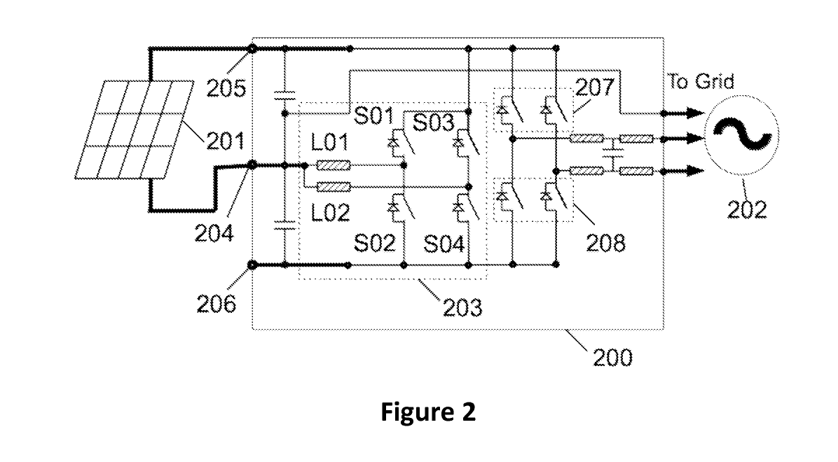

In one embodiment illustrated in FIG. 2, the power inverter of the present invention is a single-phase H-bridge type voltage source inverter 200 that connects a photovoltaic (PV) string power source 201 to an AC grid 202. The buck/boost circuit 203 is internal to the inverter 200 and consists of inductor component(s) L01 and L02 that connect a voltage point between the two power rails (hereafter referred to as the “neutral rail”) 204 to a system of switches S01-S04 that can connect one end of the inductor L01 or L02 to the positive 205 or negative 206 power rails with some frequency. If needed, the neutral point of the AC grid/load, which may be grounded or ungrounded, can be connected to the neutral rail 204 of the drive as shown in FIG. 2. The buck/boost circuit 203 in the illustrated embodiment of FIG. 2 consists of two interleaved, separately driven buck/boost legs, though other embodiments can include a single leg or a plurality of legs to derive the opposite voltage rail 206. In other embodiments, one of the switches of each buck/boost converter leg can be replaced with a diode or other one-way current blocking device if only unidirectional operation of the buck/boost circuit is needed. The inverter of the present invention can drive peak AC voltages that are twice as high as the primary input DC voltage, without use of a transformer. For instance, the inverter could drive single-phase 240 Vac power with a 200 Vdc power source rather than a 400 Vdc power source.

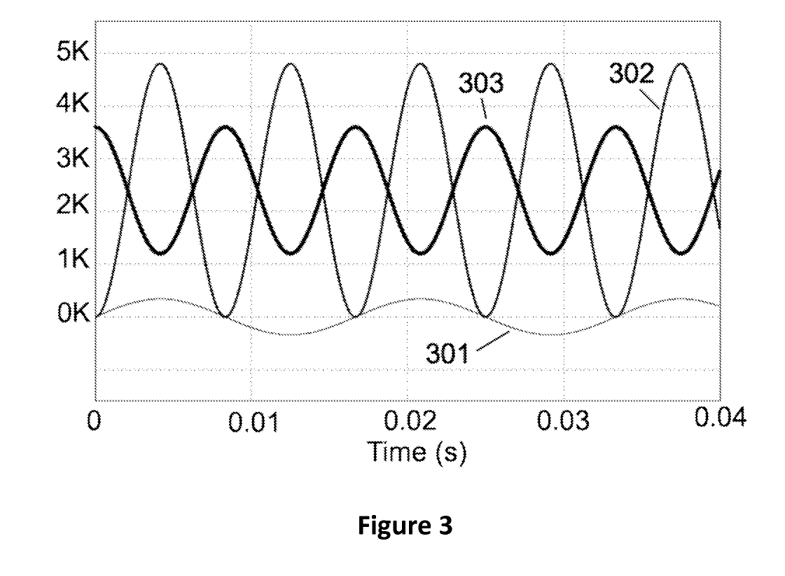

During operation of the FIG. 2 inverter 200, the photovoltaic DC power source 201 supplies DC power to the positive inverter rail, and a maximum power point tracking algorithm finds the optimal DC voltage and current conditions with which to operate while connected to the PV source 201. The upper switches of each pole 207 can connect and disconnect the grid/load to the positive rail 205, and the lower switches 208 can connect and disconnect the grid load 202 to the negative rail 206, which, in this illustrative embodiment, is also the rail derived by the buck/boost circuit 203. Thus, current delivered from the PV array flows on the positive rail and gets processed by the inverter bridge each cycle, and most of the return current is first processed by the bridge again before being processed by the buck/boost circuit 203. Under typical single-phase 60 Hz loads, the positive rail and negative rail will experience similar and simultaneous loading, with a power ripple frequency of about 120 Hz. This power ripple is reflected on the DC link, is often deleterious or non-optimal for the DC power source, and is often filtered out with DC-side capacitors in prior art. Rather than using a large capacitor bank for DC-side filtering, the buck/boost circuit 203 in the present invention can help smooth out the power ripple by boosting the derived rail to a higher-magnitude differential voltage between power peaks. For example, FIG. 3 shows grid voltage 301 and plant output power 302 in an operational mode where the buck/boost circuit processes the least amount of power 303 during output power 302 maxima and the most power during the output power 302 zero points. During each cycle, the derived rail differential voltage grows as system power output drops from its peak, reaches a maximum during the output zero crossing and then shrinks as the power output grows towards its maximum. This method of boosted capacitor operation can better utilize the DC capacitor bank as an energy storage medium and smooth out power/current ripple reflected back to the DC power source, without affecting the operating voltage and current of the primary DC power source. This method can further help filter out higher-order harmonics presented to the DC source by processing some fraction of power for the positive rail, using stored energy on the derived rail. The buck/boost circuit would drive power onto the negative rail 206 by utilizing the top switches S01 and S03 and bottom diodes S02 and S04, as well as the positive rail 205 by utilizing the bottom switches S02 and S04 and top diodes S01 and S03. Under this operating method, slightly more power would be processed by the buck/boost circuit than if no harmonic filtering function were enabled at all or if only the 2× fundamental frequency were filtered, in which case only return current would be processed by the buck/boost circuit each fundamental AC cycle. For the buck/boost operating method illustrated in FIG. 3, the buck/boost circuit helps filter some of the 2× line frequency power ripple, but not all of it. Under this method, the buck/boost circuit does not supply any power to the rail connected to the power source (positive rail), and only takes power using the top switch S01 and S03 and bottom diodes S02 and S04 in FIG. 2 (for example) such that the bottom devices S02 and S04 could just be diodes rather than switching components in parallel with diodes as drawn. At one extreme, the buck/boost circuit would process power for the negative rail asynchronously with the system's power output, just trying to process a constant power level; at the other extreme, the circuit would run peak operating power during the output power zero. This method of operation at the full inverse power extreme would almost completely eliminate 2× line frequency harmonics on the DC input; and away from the extreme, it would at least double the most prominent DC-side power frequency to a 4× line frequency ripple and could decrease the peak-to-peak ripple magnitude by any value between 0 and 100%. Reducing DC-side power ripple enables the inverter's DC input filter to be commensurately smaller.

For applications without an AC isolation transformer, the positive voltage rail and negative rail need to closely match each other to mitigate ground currents, and the filter reduction methodologies of a widely varying derived rail are no longer possible. But since the derived rail is closely regulated and does not need to withstand unloaded voltages of the power source, such as with PV panel open circuit voltages, the capacitor bank of the derived rail can have a lower voltage rating. Since capacitor voltage ratings and capacitance ratings often offset, the derived rail can have a higher capacitance and better filtering capabilities for the system overall, for a given cost.

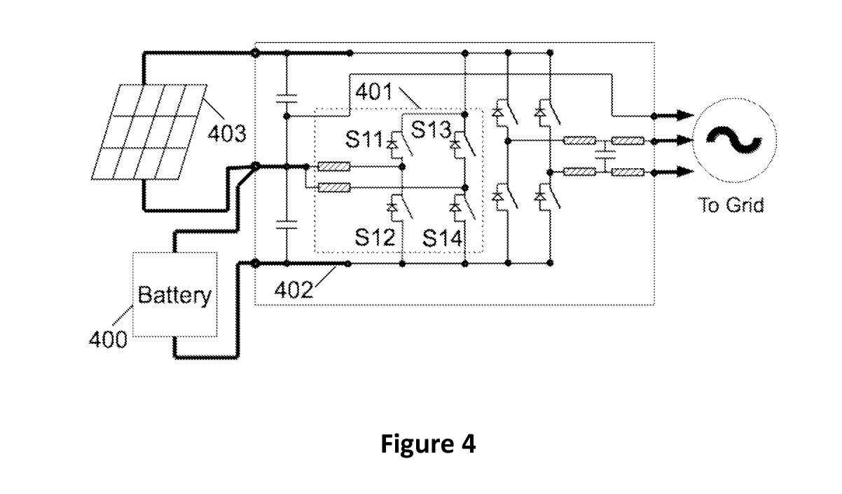

In another embodiment of the invention, an auxiliary power source is connected to the buck/boost derived rail. The auxiliary power supply could consist of any source of DC power, such as a flywheel connected to an inverter-rectifier; or energy storage, such as an electric battery. FIG. 4 illustrates an embodiment of the present invention where the embodiment previously shown in FIG. 2 has its derived leg connected to an auxiliary power source in the form of an electric battery 400. In this embodiment of the present invention, the buck/boost circuit 401 no longer can control voltage on the derived rail 402, but it can provide the same filtering, output voltage doubling, and transformerless operation functions as are possible in other embodiments. With the auxiliary power supply, the inverter can now provide power manipulation functionality, such as for enforcing power ramping limits when the primary power source is an intermittent wind or solar power source. This embodiment can also provide energy storage for load shifting, peak shaving, frequency firming and other power regulation functionalities without the need for any additional power stages or significant hardware beyond the auxiliary power source. This embodiment can also function with a ground point on the neutral rail, simultaneously grounding both the auxiliary power source 400 and primary power source 403. If both the top buck/boost switches S11 and S13 and bottom switches S12 and S14 are used as bidirectional switches, then the buck/boost circuit is bidirectional and can supply all output power, some fraction of the output power, sink all of the available input primary power, sink some fraction of the input primary power, or sink all of the available primary power in addition to power from the grid connection.

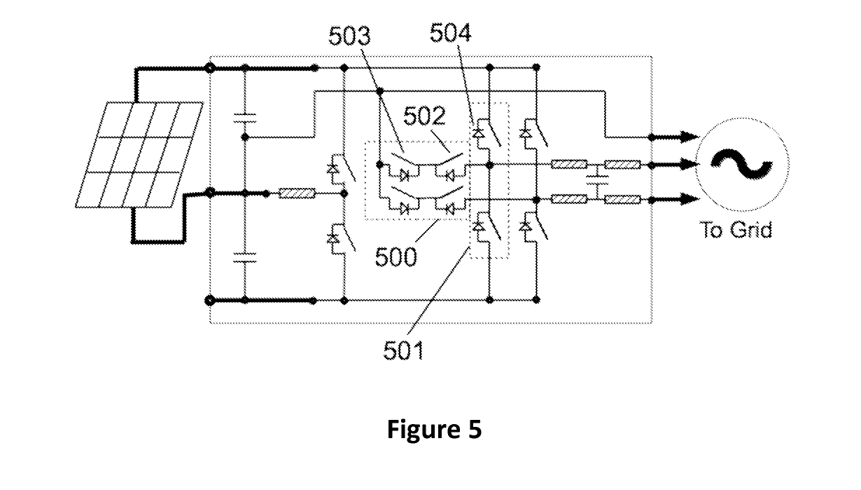

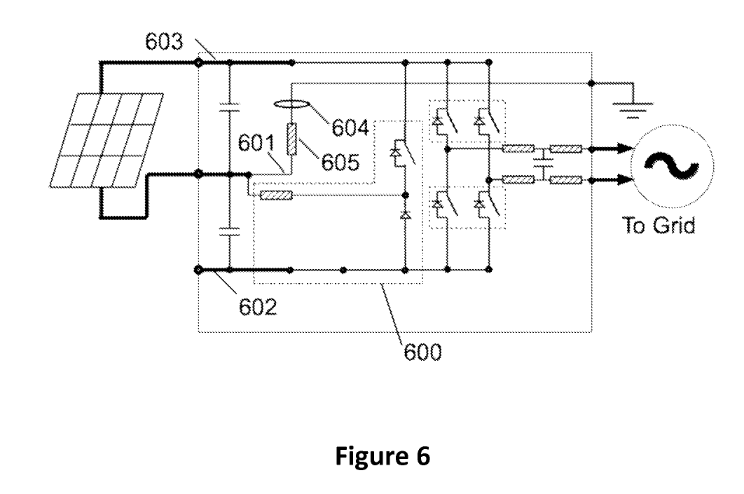

In various embodiments, the primary power source can be connected to the neutral rail and positive rail with the negative rail derived, or it can be connected to the neutral rail and negative rail with the positive rail derived. In another embodiment, the primary source is connected to the negative rail and positive rail, and the buck/boost circuit is just used for neutral point balance for various purposes including driving ground currents to zero. In various embodiments, the drive neutral point is grounded or ungrounded, and the grid/load is ground-referenced or floating. In another embodiment, the buck/boost converter included in the present invention is coupled to other modern single phase transformerless topologies, such as the H5, H6 (DC bypass), and HERIC topologies. In one operational methodology, the positive and negative rail differential voltages are approximately equal in magnitude with respect to the neutral point, and the amount of time that the grid/load is connected to each rail per switching period is equal, for various purposes including to minimize common mode currents. With this methodology in a single-phase inverter, for example, the output states of the two phase legs are always opposite so that the output common mode is always neutral, or ground if the neutral point is grounded. In a 3-phase 3-level neutral point clamped inverter, this methodology requires that the output states for all three poles always add to zero, as in +1, −1, 0; or 0, 0, 0. In another embodiment, the neutral point of the present invention is coupled to the drive outputs through an embodiment of reverse blocking transistors, as shown in FIG. 5. In the illustrative FIG. 5 embodiment, one of the neutral point transistors 500 is turned on for each output current half-cycle, and current goes through the other device's diode. For example when current is positive (flowing out of the inverter and into the grid) in the left leg 501, the positive-current blocking device 502 turns on for the positive current half cycle, and current through the diode 503 flows whenever bridge switch 504 is turned off. This embodiment of the present invention allows each bridge access to the drive neutral point between switching pulses, rather than the opposite rail, which lowers the burden on the drive's common mode filter and allows for smaller differential filters. In another embodiment, a bipolar DC power supply, such as a bipolar photovoltaic array with or without a grounded center-point, is connected to the three DC terminals of the present invention. According to this embodiment, each half of the bipolar supply can run at separate voltage and current conditions with the buck/boost circuit making up the difference in current and voltage between the two halves of the supply. Allowing for power supply operation under different conditions further allows for connection to a non-symmetric power supply (a bipolar photovoltaic string with different numbers of panels in each half, for example), and it enables separate maximum power point algorithms to be run on each half of the supply, optimizing power output for the system.

In another embodiment of the present invention, the primary generating system includes one or more DC/DC converters in-between the generating power source and the generating plant's grid-connected inverter such that the inverter of the present invention runs at a constant DC link voltage during normal non-curtailed operation, and the MPPT functionality resides in the single or plural DC/DC converters. In this type of system configuration, the DC link voltage is usually regulated by the inverter, so the inverter of the present invention would regulate the voltage rail connected to the primary source at a constant, optimal value, and regulate the derived rail according to the desired mode of operation.

In one control methodology embodiment, the buck/boost circuit of the present invention assists in detection of external system ground faults. FIG. 6 illustrates a system embodiment that can use the buck/boost circuit 600 to detect ground faults per the embodiment of this control methodology. Transformerless systems with a grounded neutral rail 601 can drive ground currents if voltage levels of the negative 602 and positive rail 603 are not matched exactly. As a corollary, small ground currents can be driven by the buck/boost circuit 600 of the present invention by modulating the mismatch between the two voltage links at a prescribed frequency. A small current sensor 604 or voltage sensor and a non-resistive impedance 605 at the system ground point (typically inside the inverter) can detect the small-signal ground current or voltage being driven by the inverter, detect any changes to the small-signal signature, and determine whether an external system conductor has been connected to ground. In addition to detecting classic ground faults of a live conductor, this fault detection methodology can also be used to detect external faults to the grounded conductor. Inverter systems of prior art cannot detect ground faults on a conductor that is intentionally grounded at another point in the system without additional costly hardware.

For many embodiments of the present invention, desired characteristics over prior art include a wide DC input range and the ability to connect a simple two-wire grounded primary power source, such as a PV string, to a ground-referenced grid without the use of a bulky and costly isolation transformer. The present invention lends itself to low cost light-weight designs because it does not require any magnetic components for galvanic isolation. For embodiments that include an auxiliary power source, as illustrated in FIG. 4, common and often competing performance goals for the auxiliary power source of the present invention include, but are not limited to, the ability to control system power, power ramp rates, battery state of charge, AC frequency support, grid backup, microgrid functionality, utilization of excess generating plant capacity, and other ancillary functionalities.

What is claimed is:

1. An apparatus comprising
a connection to a DC power source;
a connection to an AC grid or AC load; and
an inverter that contains
1) a positive DC voltage rail,
2) a negative DC voltage rail,
3) a voltage rail whose DC voltage is between the voltages on the positive and negative rails,
4) a plurality of switching elements that can connect each leg of the AC grid or load to either the positive or negative rail, and
5) a buck/boost circuit that drives voltage on one of the rails from the two rails connected to the DC power source, by driving current to and from the between-rail through an inductor connected to the positive and negative rails through switching devices.

2. The apparatus of claim 1, wherein any one or multiples of one of the inverter, buck/boost circuit, primary power source connection, DC connections, or AC connections consists of a plurality of such components.

3. The apparatus of claim 1, wherein the power inverter consists of a single-phase or three-phase voltage-source inverter full bridge, three-level NPC, H5, H6, or HERIC topology.

4. The apparatus of claim 1, wherein the DC connection is made to a photovoltaic power plant or wind turbine power plant.

5. The apparatus of claim 1, wherein the DC connection is made to the constant or varying DC link of a larger energy generation plant.

6. The apparatus of claim 1, wherein the neutral point of the grid/load connection is connected to the inverter between-rail or neutral point.

7. The apparatus of claim 1, wherein the DC connection has a grounded or ungrounded rail and the grid/load has a ground point or is floating.

8. The apparatus of claim 1, wherein the buck/boost derived rail of the inverter is connected to an auxiliary power source.

9. The apparatus of claim 8, wherein any one or multiples of one of the auxiliary power supply, inverter, buck/boost circuit, primary power source, DC connections, or AC connections consists of a plurality of such components.

10. The apparatus of claim 8, wherein the auxiliary power source is an electric battery or supercapacitor.

11. The apparatus of claim 8, wherein the auxiliary power source is a rectified AC source powered by a rotating machine.

12. A method for controlling the apparatus of claim 1 such that the derived inverter voltage rail is controlled to a constant voltage value.

13. A method for controlling the apparatus of claim 1 such that the derived inverter voltage rail is controlled to help filter DC power ripple by storing energy between output power peaks of 2× the fundamental AC frequency.

14. A method for controlling the apparatus of claim 1, wherein the derived rail voltage is driven with a small-signal AC voltage on top of the DC voltage in order to cause small-signal ground currents or voltages that can be used for conveying information, such as notification of the existence of a ground fault.

15. A method for controlling the apparatus of claim 8 such that the derived inverter voltage rail is controlled to a constant power or current output or input.

16. A method for controlling the apparatus of claim 8 such that the derived inverter voltage rail is regulated to help filter primary DC power ripple, wherein the method is accomplished by storing energy between output power peaks of fundamental AC frequency harmonics.

17. A method for controlling the apparatus of claim 8 wherein the buck/boost circuit is bidirectional and can drive current into or out of the supplied voltage rail such that the derived rail can instantaneously supply all system output power, some fraction of the output power, sink all of the available input primary power, sink some fraction of the input primary power, or sink all of the available primary power in addition to power from the grid connection.

18. A method for controlling the apparatus of claim 8 to enable absolute output power control functionality beyond the functionality that is possible when connected only to an intermittent power source, the method comprising:
1) predetermining a desired time-based power output behavior of the energy generation plant either per schedule input or by processing real-time power commands;
2) determining power delivered by the primary power source to the grid or load per AC voltage and current measurements or per DC current and voltage measurements; and
3) controlling power generation plant output by controlling power to and from the auxiliary power source based on the aforementioned voltage and/or current and/or predetermined power output behavior.

19. The apparatus of claim 1 or of claim 8, wherein the buck/boost circuit is internal to the inverter, or wherein the buck/boost circuit is external to the inverter.

20. The apparatus of claim 1, wherein a bipolar primary supply is connected to all three DC terminals/voltage rails of the apparatus.

21. The apparatus of claim 20, wherein the bipolar primary supply is a bipolar photovoltaic array consisting of a plurality of photovoltaic elements with a grounded or ungrounded point between two sets of photovoltaic elements that is connected to the inverter neutral voltage rail.

22. A method for controlling the apparatus of claim 20, wherein both the negative and positive inverter voltage rails are driven to differential voltages of the same magnitude, with respect to the inverter neutral point.

23. A method for controlling the apparatus of claim 20, wherein the negative and positive inverter voltage rails are driven to different voltage and operating currents to fulfill an operational goal, including the goal of maximizing the amount of power extracted from the primary supply.

24. A method for controlling the apparatus of claim 1 or claim 8, wherein the inverter neutral rail is connected to a network that is connected to the neutral of a center-tapped transformer and the apparatus is controlled such that current in the transformer is balanced between phases.

25. A method for controlling a bipolar supplied inverter wherein the voltage rails are driven with a small-signal AC voltage on top of the DC voltage in order to cause small-signal ground currents or voltages that can be used for conveying information, such as notification of the existence of a ground fault.
